(19) United States
(12) Patent Application Publication
(10) Pub. No.: US 2002/0178269 A1
(43) Pub. Date: Nov. 28, 2002

(54) Method for a distributed system for the provision of at least one service, and client, client-service management module and database for the same

(75) Inventor: Ralf Suckow, Berlin (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/151,015

(22) Filed: May 21, 2002

(30) Foreign Application Priority Data
May 22, 2001 (EP) 01 440 141.8

(51) Int. Cl. G06F 15/173; G06F 15/16

(52) U.S. Cl. 709/228; 709/225

(57) ABSTRACT

The present invention concerns a method for a distributed system for the provision of at least one service, which can be respectively provided by a first or at least one second server for a first or at least one second client. The invention furthermore concerns, for the same, a client, a client-service management module and a database.

### BACKGROUND OF THE INVENTION

The invention is based on a priority application EP 01 440 141.8 which is hereby incorporated by reference. The present invention concerns a method for a distributed system for the provision of at least one service which can be respectively provided by a first server or at least one second server for a first client or at least one second client. The invention furthermore concerns, for the same, a client, a client-service management module, a database and a client group.

In the case of distributed systems, for example, network management systems or systems for the provision of video data, it is known that one service is alternatively provided by several servers for several clients. In the case of a network management system, for example, such a service is the handling of alarm messages which are sent first by network nodes of the telecommunications network managed by the network management system to clients which then request from servers processing services for the alarm messages. The clients are, for example, client computers which are remote from server computers and are connected to one another via, for example, telecommunications networks, or they are client applications which are executed together on a computer and request the services of server applications which are executed by one or more separate computers.

A scenario can be such, for example, that client computers, for example personal computers, request video data from so-called streamed-video proxy servers, which then transmit this data to the client computers. One proxy server can service several client computers. Inversely, a client computer can request the video data not merely from one proxy server but also, alternatively, from another proxy server. Several alternative servers, in practice several proxy servers, can be provided, for example, for reasons of optimum load distribution and/or for reasons of redundancy.

A client computer which requires a service from a server, for example, a client computer which requires video data from a proxy server, may possibly need to request this service from several servers before it finds such a server which can provide the desired service in the required service quality. The service quality in this case depends not only on the quality of the server or its load situation, but also on the respective connection quality of the respective connections between the servers and the client computer.

Even if one were to connect several servers together to form a local server network and connect ahead of them a load distributor by which a request by a client computer for a service was forwarded to such a server of the server network capable of providing the service in an adequate service quality, the problem still remains that the connection between the selected service server and the client computer can be overloaded or affected by interference with the result that, ultimately, the service, for example the sending of video data, cannot be provided in the required service quality. Moreover, this solution is only practicable if the servers are relatively close to one another, for example, connected to one another via a local network.

The same problems, essentially, also occur if the clients are client applications which are executed by a first computer and the servers are server application which are executed on one or more further computers which are connected to the first computer via, for example, a local network.

### SUMMARY OF THE INVENTION

The object of the invention, therefore, is to improve the quality of the service provision in a distributed system.

This object is achieved by a method according to the technical instruction of Claim 1. Also provided for the purpose of achieving the object are a client, a client-service management module, a database and a client group according to the technical instructions of further independent claims.

A fundamental concept of the invention consists in several clients, which can respectively request services from alternative servers, being combined to form a client group. The clients report, as it were, to one another their experiences with the service provision by the different servers. The clients respectively determine at least one quality characteristic in respect of the service provision by a server. The quality characteristic is entered, related to the respective server, into a client-side database. The quality characteristic can be, for example, the respective availability of their servers. Upon a subsequent request of the service by one of the clients of the client group, the client-side database is used as the basis for selecting a suitable server for the provision of the service. The suitable server is selected on the basis, as it were, of the experiences which the clients of the client group have had with the servers since that time.

Since the database is located with the clients, only a very small amount of communication is required for maintenance of the database. Moreover, such a database can be created in a relatively simple manner. The evaluation of the quality of the service provided by a particular server also takes account of the quality of the respective connection between the server and client. The clients of the client group are located relatively close to one another, whilst the servers are relatively remote from the client group. The terms “close” and “remote” are to be understood in this case as spatially close and remote and/or as rapid and slow communication respectively and/or as communication at low and high cost respectively and/or as communication via a reliable and an unreliable connection respectively. In any case, in respect of the service quality, it is of scarcely any importance whether a server provides a service for a first client of the client group or for a second client of the client group.

Advantageous developments of the invention are disclosed by the dependent claims and by the following description.

Provision is advantageously made whereby the clients themselves determine the at least one quality characteristic for the quality of the provision of the service. In principle, however, it is also conceivable for a separate module to be provided for this purpose. For example, a router, via which the clients of the client group are connected to a server, could evaluate the quality of the service provision. For example, a router could determine whether video data is transmitted with the required continuity. It is to be noted at this point that, although it is advantageous if, when a service is provided by a server, each client of the client group evaluates the respective quality and enters this in the client-side database, it is nevertheless also possible for only some of the clients to perform such an evaluation, while other clients of the client group, although benefiting from these experiences in the selection of a server for the provision of a service, nevertheless do not themselves perform a quality evaluation and enter the thereby determined results in the database.

Provision is advantageously made whereby, when a service is requested, the clients themselves evaluate the data entered in the database. However, it is also conceivable that, for the purpose of selecting a suitable server, a client-service management module is provided, for example, a program module by which a request for a service sent by a client of the client group is forwarded to a suitable server which is determined by the client-service management module on the basis of the quality characteristics entered in the database.

The client-service management module advantageously enters in the database the quality characteristics relating to the server. The client-service management module can be executed by one of the clients of the client group or can also be contained, for example, in an interface device, e.g. a router, of the client group.

Provision is advantageously made whereby, if the quality characteristics which are entered in the database for different servers in respect of their respective service provision essentially correspond, i.e., if the servers can provide the respective service with basically the same quality, a suitable server is selected on the basis of a random selection and/or according to a predefined load distribution criterion. Otherwise, several clients might possibly direct their service requests to the same server, which could result in an overload situation in this server. The load can be distributed stochastically, for example through a random selection and/or, for example, according to a rotation principle in which service requests are directed in rotation to all servers which are evaluated in the database as essentially the same in respect of their quality. Such a method is known as a “round robin”.

There are numerous possibilities for realization of the concept according to the invention: for example, the clients can be client computers, and the servers can be server computers which are connected to the clients via one or more telecommunications networks, for example, wide area networks (WANs). The latter, in turn, are connected to one another via, for example, a local area network (LAN). In a further embodiment of the invention, the clients are client applications, i.e. client programs, which are executed by a computer. For the client applications, services are provided by different servers, which can be server computers or server applications, which are connected via, for example, a local network, to the computers executing the client applications.

### BRIEF DESCRIPTION OF THE DRAWINGS

Some embodiment examples of the invention are explained more fully below with reference to the drawing, wherein:

FIG. 1 shows an arrangement for executing the method according to the invention, with client groups G1, G2; G3, of which the clients C1-C3; C4, C5 and CA1-CA3 respectively are provided with services by servers P1-P3,

FIG. 2 shows a detailed, but schematic view of the client C1,

FIG. 3 shows a schematically represented client-service management module DM1 of the client group G1, and

FIG. 4 shows client-side databases DB2, DB3 of the client groups G2, G3.

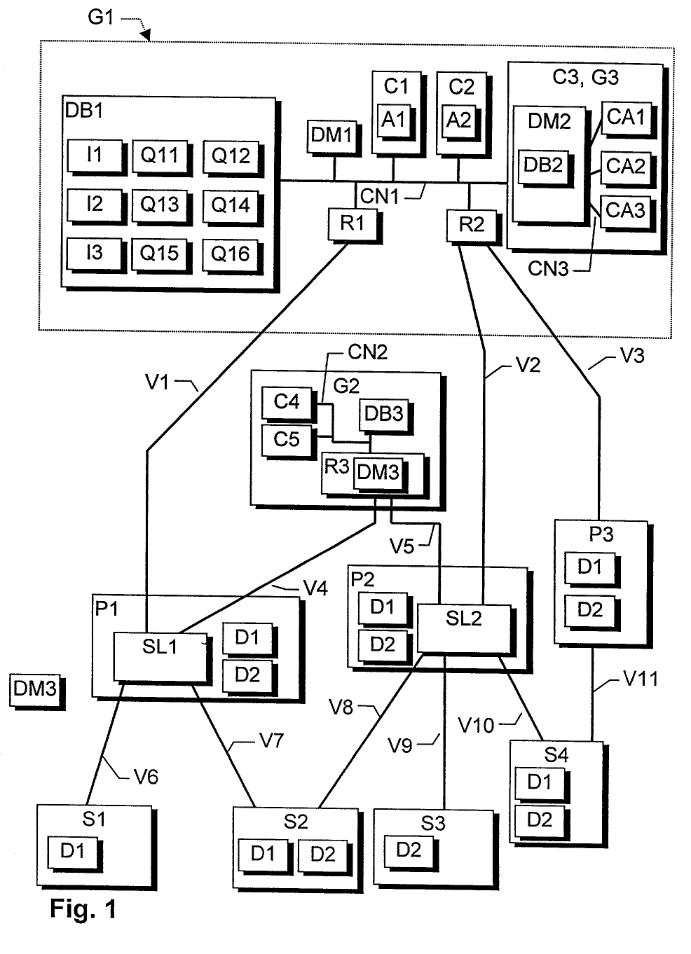

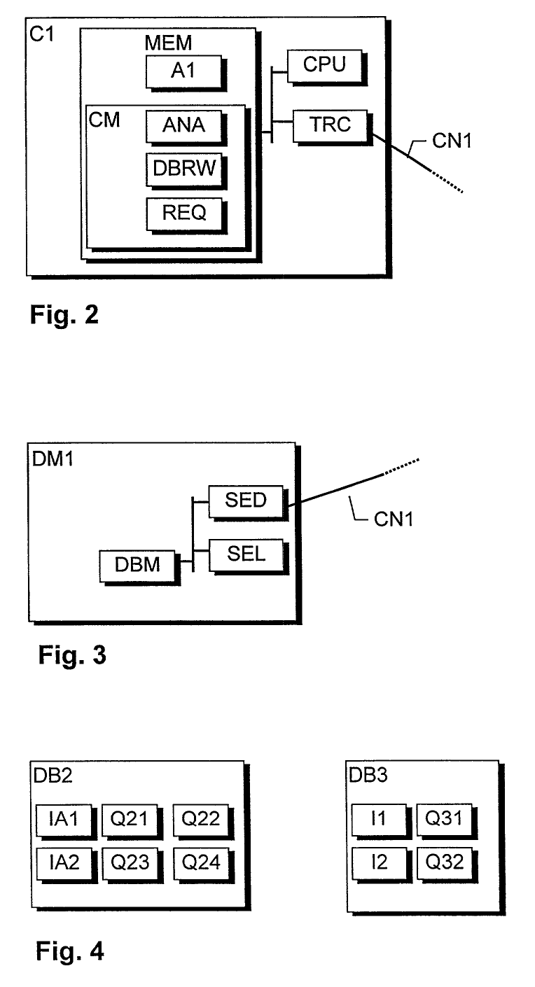

FIG. 1 shows, in schematic form, several embodiment examples of the invention, which are explained in detail in the following:

In the case of a client group G1, clients C1, C3, C3, which are, for example, personal computers operating as client computers, are connected to one another via a client network CN1, which is, for example, a fast Ethernet LAN. Via routers R1, R2, serving as an interface device, the clients C1-C3 of the client group G1 can establish connections V1, V2, V3 to proxy servers P1, P2 and P3 respectively. The router R1 services the connection V1 and the router R2 services the connections V2, V3. The connections V1 to V3 pass, for example, via long-distance networks, not represented, e.g. via one or more telephone networks. In this case, anyway, the transmission rate on each of the connections V1-V3 is lower than on the client network CN1.

In the embodiment example, the proxy servers are servers which can supply video data to the clients C1-C3 and to clients C4, C5 of a client group G2, to be described at a later point, and to further clients and/or client groups which are not represented. The proxy servers P1-P3 serve to locally distribute the video data which are provided by source servers S1-S4. The source servers S1-S4 are located, for example, in the USA, and the proxy servers P1-P3 in Europe. The video data is transmitted using, for example, a real-time protocol or a so-called real-time streaming protocol. The proxy server P1 can load video data D1 from the source server S1 via a connection V6 or, alternatively, from the source server S2 via a connection V7. For this purpose, the proxy server P1 is provided with a selection module SL1 which loads the video data D1 from the source server S1 or S2 according to its availability. In the proxy server P2, a selection module SL2, performing the same function as the selection module SL1, loads the video data D1, D2 from the source server S2 via a connection V8, from the source server S3 via a connection V9 or from the source server S4 via a connection V10. The proxy server P3 loads video data from the source server S4 via a connection V11.

A client-side databank DB1 connected to the client network CN1 stores identifiers I1-I3 by means of which the proxy servers P1-P3 can be identified. The identifiers I1-I3 can be, for example, address information for the proxy servers P1-P3. In any case, the identifiers I1-I3 identify a service resource which is available for the client group G1.

If, for example, the client C1 requires the video data D1, for example, because a user of the client C1 wishes to see a particular video film, the client C1 must request this video data from one of the proxy servers P1-P3. The client C1 then sends, for example, a request to the database DB1, in order to be informed of the identifiers I1-I3. In the case of a conventional system, the client C1 would have to select any one of the proxy servers P1-P3, for example, according to the random principle, in order to request the video data D1 from it. In the case of the system according to the invention, however, quality characteristics Q11, Q12 are stored in respect of the identifier I1, quality characteristics Q13, Q14 are stored in respect of the identifier 12 and quality characteristics Q15, Q16 are stored in respect of the identifier I3. The quality characteristics Q11, Q13, Q15 represent, for example, the respective availability of the proxy servers P1-P3, the quality characteristics Q12, Q14, Q16 representing their respective response times. Further quality characteristics can be, for example, the qualities of the connections V1, V2, V3 to the proxy servers P1-P3, and charges incurred for the provision of a service, in the actual example, for the downloading of video data, by the respective proxy servers P1-P3. Further quality characteristics are easily possible. In the case of the present example, the client Cl determines, on the basis of the quality characteristics Q11-Q16, that the proxy server P1 is optimally suitable for the downloading of the video data D1. The client computer C1 therefore sends the request for the video data to the proxy server P1. Initially, the proxy server P1 supplies the video data D1 in the desired quality.

It is to be assumed that the proxy server P1 subsequently comes into an overload situation due to further requests, for example because, in addition to the client C1, the client C4 requests the video data D1 from it. The degraded quality of the service provision is ascertained by the client C1 and entered in the database DB1, for example, the value of the quality characteristic Q11 is lowered. If the client C2 then requires the video data D1, it can determine, on the basis of the database DB1, that the proxy server P1 cannot for the time being supply the video data D1 with the required quality. By contrast, the proxy server P2 would be capable of supplying it. The client C2 can ascertain this by the fact that, for example, the value of the quality characteristic Q13 is higher than the value of the quality characteristic Q11. The client C2 therefore sends its request for the transmission of the video data Dl to the proxy server P2. The client C2 also determines the quality with which the video data D1 is supplied. The client C2 modifies the value of the quality characteristic Q13 accordingly. If, for example, in the transmission of the video data D1, the charges incurred are reduced, the client C2 changes the value of the quality characteristic Q14 accordingly.

The load situation of a proxy server P1, P2 or P3 depends on various influencing variables, for example, on the time of day (particularly large amounts of video data are requested in the evening), on the capacity of the particular computer (processor capacity or the like), and/or on the number of connected client computers. A particular problem in the loading of video data is that, in the case of a proxy server, the log-on process can take several seconds, and in some cases up to a minute, the client already loading video data into an intermediate buffer memory, and that it is not yet possible for video data to be displayed during the log-on process. Changeover between different proxy servers P1-P3 during the playback of a video is therefore not appropriate. Consequently, in the case of a short-term interruption of a loading operation, for example, a load peak, changeover is not immediately effected from one proxy server to another proxy server. It is also essential in this connection that quality evaluations relating to the respectively provided service quality have a relatively long observation horizon in each case, i.e., the quality with which the particular video data is supplied by a proxy server P1-P3 is observed and analysed over a relatively long period of time.

Although the client C3 uses the database DB1 to determine which of the proxy servers P1-P3 is optimally suitable for loading the video data D1 or D2, unlike the clients C1, C2, the client C3 does not alter the values of the quality characteristics Q11-Q16 if a quality criterion changes during the transmission of the respective video data. Although the client C3 benefits from the “experiences” that the clients C1, C2 enter in the database DB1 in the form of quality characteristics Q11-Q16, it does not contribute to its maintenance.

The database DB1 can be, for example, a databank, a file stored on a computer of the client group or a file directory provided on it, or a temporary memory area, for example, located in a RAM (random-access memory), into which the clients C1, C2 enter the quality characteristics Q11-Q16. It is understood that the database DB1 can be empty when the client group G1 is set up, i.e., although the identifiers I1-I3 are entered, the quality characteristics Q11-Q16 are determined by the clients C1, C2 upon the respectively first request of a service from the proxy servers P1-P3 and entered in the database DB1. It is also conceivable for typical experience values, for example, mean values, to be entered for the quality characteristics Q11-Q16.

If the quality characteristics Q11-Q16 for two or more of the identifiers I1-I3 essentially correspond, the respective proxy servers P1-P3 are, basically, equally suitable for performing a service. This can result, for example, in each of the clients C1-C3 sending a request for the video data D2 to the proxy server P1. This, however, could result in an overload of the proxy server P1. Provision is advantageously made, therefore, whereby, in the case of quality characteristics Q11-Q16 of at least two proxy servers P1-P3 being essentially equal, one of the latter is selected according to a random principle. For example, in respect of the identifiers I1 and I2, the quality characteristics Q11, Q12 and Q13, Q14 respectively could be equal. The clients C1-C3 could then select the identifiers I1 or I2 according to the random principle. It is also possible for the identifiers I1, I2 to be selected alternately in such a case.

The database DB1 can also be managed through a databank application, for example, an appropriate program. In such a case, the clients C1, C2 send requests to the corresponding databank application for modification or read-out of the values of the quality characteristics Q11-Q16. The database DB1 can also be contained, however, in one of the clients C1, C2 or C3. For example, for the clients C1-C3, the client C1 is explained more fully below:

In the case of the embodiment example, the client C1 is a personal computer with memory means MEM which are, for example, RAM modules, hard-disk drives or the like, with a control means CPU which is, for example, a processor or a cluster of processors, and with connection means TRC which serve to connect to the client network CN1, the said connection means being, for example, a fast Ethernet interface card. For reasons of simplification, further components of the client C1, such as a monitor, a keyboard or a mouse, are not shown in the embodiment example. The control means CPU controls the functions of the client C1 under the control of an operating system, for example, Unix, and with the cooperation of program modules, for example, of an application module A1 and a client module CM, which are stored in the memory means MEM and comprise program code which can be executed by the control means CPU.

The client module CM contains analysis means ANA by means of which the client module CM can determine the quality of services which the proxy servers P1-P3 provide for the client C1, transmission and write means DBRW, by means of which the client module CM can transmit the thus determined quality characteristics to the database DBI, and request means REQ, by means of which the client module CM, on the basis of the data entered in the database DB1, can select a suitable proxy server P1, P2 or P3 for the provision of a service, namely, the transmission of video data D1 or D2. The analysis means ANA, the transmission or write means DBRW and the request means REQ are, for example, program functions. The client module CM is, for example, generated in a standard language, e.g. C, C++ or JAVA, and converted, by means of a compiler, into program code which can be executed by the control means CPU.

By means of the client module CM, the client C1 can execute the functions, already described above, by which one of the proxy servers P1-P3 was selected for the provision of a service, namely, the loading of video data D1. In addition, the client module CM uses the analysis means ANA to perform a quality evaluation of the services provided in this connection. The client module CM can also be contained in the clients C2 and C3 and be executed by control means contained in each of the latter. It is also possible, however, for the clients C1-C3 to be provided with appropriate hardware modules, instead of the client module CM.

Furthermore, the clients C1-C3 can give a client-service management module DM1, referred to below in brief as a management module DM1, the task of selecting a suitable proxy server P1-P3, on the basis of the quality characteristics Q11-Q16 stored in the database DB1, for the provision of a service for the respective client C1-C3. Even if the clients C1-C3 are provided with client modules CM with request means REQ, the inclusion of the latter module per se is not essential, since its function can also be performed by the management module DM1. This is explained more fully below:

The management module DM1 constitutes a component part of the client group G1 and is connected to the client network CN1. The management module DM1 is, for example, a computer which comprises transmission and receiving means SED, and selection means SEL, the respective functions of which are to be explained. The management module DM1 can be realized as hardware, or as software that is executed by a computer, for example, a personal computer. The aforementioned transmission and receiving means and the selection means are then realized as corresponding program functions. It is also possible for the management module DM1 to be a program module executed by one of the clients C1-C3.

It is to be assumed in the following that the client C2 does not comprise a client module CM1. The client C2 therefore first sends a request for the loading of video data D2 to the management module DM1. The latter receives the corresponding service request by means of its receiving means SED and forwards it to selection means SEL which determine, for example, on the basis of the quality characteristics Q11-Q16 entered in the database DB1, that the proxy server P1 is currently best suited for loading of the video data D2. The transmission and receiving means SED therefore send a request for loading of the video data D2, via the router R1, to the proxy server P1, which thereupon sends the video data D2 to the client C2.

The client C2 analyses the quality with which this service is provided by the proxy server P1. The corresponding result of the analysis is entered in the database DB1 by, for example, the client C2 itself. It is also possible, however, for the client C2 to transmit the corresponding quality characteristics to the management module DM1, which then, by means of its management means DBM, enters the quality characteristics relating to the server providing the respective service, in the example, relating to the proxy server P1, into the client-side database DB1.

A further embodiment of the invention is explained in the following with reference to the client group G2 with the clients C4 and C5. The clients C4, C5 are connected, via a client network CN2 which is, for example, a local network with a high transmission rate and/or high reliability, to a router R3 which enables the clients C4, C5, via connections V4, V5, to access the proxy servers P1, P2, or their services. In comparison with the client network CN1, the connections V4, V5 are, for example, less reliable, e.g. because overload situations can occur comparatively frequently on these connections, and/or permit data transmission at a lower transmission rate than is the case with the client network CN2.

Unlike the clients C1-C3, the clients C4, C5 do not contain a client module CM. Instead, the router R3, which represents an interface device, contains a client-service management module DM3 which performs basically the same functions as the service management module DM1 of the client group G1. The management module DM3, however, is a program module which is executed by the router R3 or by a processor, not represented, of the router R3.

Additionally provided in the case of the client group G2 is a database DB3 which is designed as a separate unit and is connected, via the client network CN2, to the clients C4, C5 and to the router R3. However, the client-side database DB3 could also be contained in the router R3, for example, as a file, a directory system or as a databank module.

The clients C4, C5 each send requests for the provision of a service, for example, for the loading of video data D1 or D2, to the router R3. Its management module DM3 then determines which of the proxy servers P1, P2 is best suited for this in each case. The management module DM3 does this by evaluating the quality characteristics Q31, Q32 that are entered in the database DB3 in respect of identifiers I1 and I2. According to the quality characteristics Q31, Q32, the management module DM3 then sends service requests for the loading of video data D1, D2 to one of the proxy servers P1 or P2.

The services of the proxy servers P1, P2 which are thereupon provided are evaluated by the management module DM3, or the router R3. For example, the response time of the proxy servers P1, P2 is analysed as a quality characteristic. It is also possible for the management module DM3 to monitor whether the video data D1 or D2 is supplied with adequate continuity. The management module DM3 enters the respective result, as a quality characteristic Q31 or Q32, in the database DB3.

It is also possible for the quality characteristics Q31, Q32 to represent quality indices which include several quality criteria. For example, such a quality index could include the availability of a respective proxy server P1, P2, as well as its respective response time and/or the charges incurred for the provision of the service by the respective proxy server P1, P2. In addition, it is possible for the different criteria to be weighted.

In the case of all aforementioned embodiments of the invention, it is clear, in respect of the client groups G1, G2, that their clients C1-C3 and C4, C5 respectively each benefit mutually from the experiences of other members of the respective client group G1, G2 in respect of the provision of a service by the proxy servers P1-P3. These “experiences” include not only the respective qualities of the proxy servers P1-P3, for example, their respective availabilities, but also the quality of the connections V1-V3 and V4, V5 respectively. In each case, it is of no significance that the clients C1-C3 and C4, C5 respectively are separate devices, since they are connected by internal client networks CN1 and CN2 respectively which are “better” than the connections V1-V3 and V4, V5 respectively because, for example, they have a high transmission rate and/or availability or because only low costs are incurred for the transmission of data on the client networks CN1, CN2. The clients C1-C3 and C4, C5 are, as it were, close to one another in each case. This also applies to the database DB1 and DB3 respectively assigned to them. In this connection, a difference in respect of the selection modules SL1, SL2 also becomes evident: the latter do not benefit mutually from the experiences of the respectively other selection module SL2 or SL1 with the provision of services by the servers S1-S4. For example, the failure of the server S2 is not communicated to the selection module SL1 by the selection module SL2, as a result of which the server SL2 cannot provide in the desired quality, i.e., cannot provide at all, a service requested from it, namely, the downloading of video data D1 or D2.

A further embodiment example of the invention is explained with reference to the client applications CA1, CA2, CA3, which are program modules executed by the client C3 and are members of a client group G3. The client applications CA1-CA3 are program modules which are executed by the client C3, for example, by a processor or by a processor arrangement. For example, the client applications CA1-CA3 could each be network management program modules which monitor and control network devices, e.g. the proxy servers P1-P3.

The client applications CA1-CA3 require a service which can be provided either by a service application A1 or by a service application A2. The service applications A1 or A2 could also be termed server applications. In any case, in the embodiment example, the service applications A1, A2 are program modules whose program code is executed by the clients C1 and C2 respectively.

In the case of a constellation, in which the client applications CA1-CA3 are network management program modules, the proxy servers P1-P3 send, for example, event messages, e.g. alarm messages, measured-value messages or the like, to the client applications CA1-CA3 for further processing. The latter log the respective event message and/or display them on a user interface and/or perform other processing of the event messages. For example, one of the proxy servers P1-P3 could communicate an overload situation to the client application CA1. In order to remedy the overload situation the client application CA1 requires, for example, a service which can be provided by the service application A1 or the service application A2. The service could be, for example, a complex load distribution calculation. In any case, the service must be provided as optimally as possible by one of the service applications A1 or A2.

The client application CA1 sends a corresponding service request to a service management module DM2, which is a program module whose program code is executed by the client C3. The management module DM2 has essentially the same functionality as the management modules DM1, DM3. Unlike the latter, the management module DM2 comprises an integrated client-side database DB2 in which are entered quality characteristics Q21, Q22 in respect of an identifier IA1 for the application A1 and quality characteristics Q23, Q24 in respect of an identifier IA2 for the application A2. The quality characteristics Q21-Q24 are, for example, the respective response behaviours of the applications A1, A2 in responding to a service request.

In addition, the quality characteristics Q21-Q24 include, for example, the respective processor capacities of the clients C1 or C2, their respective interface performance in relation to the client network CN1 or the like. In any case, the management module DM2 selects, on the basis of the quality characteristics Q21-Q24 entered in the database DB2, the application A1 or A2 which can process the service request sent by the client application CA1 with the best service quality. Accordingly, the management module DM2 sends a corresponding service request to one of the applications A1 or A2, e.g. the application A1. The quality of the service that is subsequently provided by the respective application A1 or A2 is analysed by the management module DM2 and/or by the respective client application CA1-CA3. The respective result is entered in the client-side database DB2.

Any combinations of the measures disclosed in the claims and in the description are easily possible. In addition, other developments of the invention are always possible:

For example, the client C3 could be provided only with the database DB2, but not the management module DM2. The client applications CA1-CA3 would then themselves undertake the management of the database DM2, i.e., they themselves would enter the quality characteristics Q21-Q24. In addition, each of the client applications CA1-CA3 themselves would determine, on the basis of the database DB2, which of the service applications A1 or A2 is able to supply the required service quality for a service request.

1. Method for a distributed system for the provision of at least one service, which can be respectively provided by a first server or at least one second server for a first client or at least one second client of a client group
in which, upon the provision of the at least one service by the first server or the at least one second server for one of the clients of the client group at least one quality characteristic is determined which identifies at least one quality of the provision of the service by the first server or the at least one second server,
in which the at least one quality characteristic is entered in a client-side database, assigned to the client group, in respect of the first server or the at least one second server, and
in which, upon a request of the at least one service for one of the clients of the client group, the first or the at least one second server is selected on the basis of the at least one quality characteristic entered in the client-side database.

2. Method according to claim 1, wherein the first and/or the at least one second client determines/determine the at least one quality characteristic.

3. Method according to claim 1, wherein, upon a request of the at least one service, the first and the at least one second client respectively select the first or the at least one second server on the basis of the at least one quality characteristic entered in the client-side database.

4. Method according to claim 1, wherein the first or the at least one second client sends a request of the at least one service to a client-service management module of the client group, and the client-service management module selects the first or the at least one second server on the basis of the at least one quality characteristic entered in the client-side database and sends the request of the at least one service to the respective first or at least one second server.

5. Method according to claim 4, wherein the client-service management module enters in the client-side database the at least one quality characteristic in respect of the first and the at least one second server.

6. Method according to claim 4, wherein the client-service management module is contained in the first and/or the at least one second client and/or an interface device of the client group by means of which a connection can be established between the clients of the client group and the first server or the at least one second server.

7. Method according to claim 1, wherein, upon a request of the at least one service for one of the clients of the client group, the first or the at least one second server is selected on the basis of a random selection and/or according to a predefined load distribution criterion if the quality characteristics in the client-side database for the at least one quality of the service provision by the first or the at least one second server essentially correspond.

8. Method according to claim 1, wherein the members of the client group are located close to one another.

9. Method according to claim 1, wherein there is respectively determined, as the at least one quality characteristic, the respective availability of the first and of the at least one second server and/or their respective response times and/or the quality of a respective connection to the first or the at least one second server respectively and/or charges incurred for the provision of the at least one service by the first or the at least one second server.

10. Method according to claim 1, wherein the at least one service is actually used by the first client or the at least one second client of the client group.

11. Client of a distributed system, for which a service can be provided by a first server or at least one second server and which is designed to cooperate with at least one second client of the client group,
with analysis means which are designed in such a way that, upon the provision of the at least one service by the first server or the at least one second server, the client can determine at least one quality characteristic which identifies at least one quality of the provision of the service by the first server or the at least one second server,
with transmission or write means which are designed in such a way that the client can transmit to or enter in a client-side database, assigned to the client group, the at least one quality characteristic in respect of the first server or the at least one second server so that, upon a request of the at least one service for the client or the at least one second client, the first or the at least one second server can be selected on the basis of the at least one quality characteristic entered in the client-side database.

12. Client according to claim 11, wherein it comprises request means which are designed in such a way that, upon a request of the at least one service, the client can select the first or the at least one second server on the basis of the at least one quality characteristic entered in the client-side database.

13. Client-service management module for a client group with a first and at least one second client for which at least one service can be provided by a first server or at least one second server,
with receiving means for receiving a request for the at least one service sent by the first or the at least one second client,
with selection means for selecting the first or the at least one second server on the basis of at least one quality characteristic entered in a client-side database, assigned to the client group, in respect of the first server or the at least one second server, and
with transmission means for sending the request for the at least one service to the respectively selected first or at least one second server.

14. Client-service management module according to claim 13, wherein it comprises management means for entering the quality characteristic, in the client-side database, in respect of the first server or the at least one second server.

15. Database for a client group with a first and at least one second client for which at least one service can be provided by a first server or at least one second server,
in which can be entered at least one quality characteristic in respect of the first server or the at least one second server, the at least one quality characteristic being determinable upon the provision of the at least one service by the first server or the at least one second server for one of the clients of the client group and identifying at least one quality of the provision of the service by the first server or the at least one second server,
and from which the at least one quality characteristic can be read upon a request of the at least one service for one of the clients of the client group, so that the first or the at least one second server can be selected on the basis of the at least one quality characteristic.

16. Client according to claim 11 or client-service management module according to claim 13, wherein they each contain program code which can be executed by a control means of a client computer.

17. Memory means, in particular, diskette or CD-ROM, digital versatile disk, hard-disk drive or the like, with a client according to claim 16 stored thereon and/or a client-service management module according to claim 16 stored thereon and/or a client-side database according to claim 15 stored thereon.

18. Client group of a distributed system with a first and at least one second client for which the at least one service can be respectively provided by a first server or at least one second server, and with a client-side database,
the first and at least one second client and the client-side database of the client group being located close to one another,
the clients of the client group and/or a client-service management module of the client group determining, upon the provision of the at least one service by the first server or the at least one second server for one of the clients, at least one quality characteristic which identifies at least one quality of the provision of the service by the first server or the at least one second server,
the at least one quality characteristic being entered in a client-side database, assigned to the client group, in respect of the first server or the at least one second server, and
the first or the at least one second server being selected, upon a request of the at least one service for one of the clients of the client group, on the basis of the at least one quality characteristic entered in the client-side database.

19. Memory means, in particular, diskette or CD-ROM, digital versatile disc, hard-disk drive or the like, with, stored thereon, a client of a distributed system for which a service can be provided by a first server or at least one second server and which is designed to cooperate with at least one second client of the client group, the client containing program code which can be executed by a control means of a client computer,
the client containing analysis means which are designed in such a way that, upon the provision of the at least one service by the first server or the at least one second server, the client can determine at least one quality characteristic which identifies at least one quality of the provision of the service by the first server or the at least one second server, and
the client containing transmission or write means which are designed in such a way that the client can transmit to or enter in a client-side database, assigned to the client group, the at least one quality characteristic in respect of the first server or the at least one second server so that, upon a request of the at least one service for the client or the at least one second client, the first or the at least one second server can be selected on the basis of the at least one quality characteristic entered in the client-side database.

20. Memory means, in particular, diskette or CD-ROM, digital versatile disc, hard-disk drive or the like, with, stored thereon, a client-service management module for a client group with a first and at least one second client for which at least one service can be provided by a first server or at least one second server, the client-service management module containing program code which can be executed by a control means of a client computer and the client-service management module additionally containing:
receiving means for receiving a request for the at least one service sent by the first or the at least one second client,
selection means for selecting the first or the at least one second server on the basis of at least one quality characteristic entered in a client-side database, assigned to the client group, in respect of the first server or the at least one second server, and
transmission means for sending the request for the at least one service to the respectively selected first or at least one second server.
